(19) United States
(12) Patent Application Publication
(10) Pub. No.: US 2015/0212806 A1
(43) Pub. Date: Jul. 30, 2015

(54) INITIALIZATION METHOD AND INITIALIZAION SYSTEM FOR STORAGE DEVICE

(71) Applicant: Transcend Information, Inc., Taipei City (TW)

(72) Inventor: Chun-Yu HSIEH, New Taipei City (TW)

(73) Assignee: Transcend Information, Inc., Taipei City (TW)

(21) Appl. No.: 14/166,872

(22) Filed: Jan. 29, 2014

(51) Int. Cl. G06F 9/445

(52) U.S. Cl. CPC G06F 8/61

(57) ABSTRACT

An initialization method, which is suitable for a storage device including an interface, a controller module and a memory module, is disclosed. The initialization method includes following steps. A vendor command is provided from a host device via the interface to trigger a first firmware stored in the controller module of the storage device, so as to activate an initialization to the storage device. A second firmware is installed into the memory module of the storage device according to an instruction inputted from the host device via the interface and delivered by the controller module. The storage device is initialized by the triggered first firmware and the second firmware.

### FIELD OF INVENTION

The disclosure relates to a digital media storage device. More particularly, the disclosure relates to an initialization method for a digital media storage device.

### BACKGROUND

As on-line networking websites become popular, people tend to share their feelings, experiences or thoughts with their friends, families, or colleges in a form of digital files, such as photos or videos. Devices (e.g., digital cameras) utilized for capturing and creating photos/videos are highly developed and improved to capture these files at very high resolutions (e.g., 13 or more mega-pixels per photo, or 1920*1080 pixels per frame of a video).

However, storage spaces within these devices are limited by storage media, which are usually memory cards installed within the devices. On the other hand, the digital cameras are usually lack of ability to connect on-line. Therefore, photos/videos captured by the digital cameras and stored in the memory cards cannot be shared or accessed easily by other users.

### SUMMARY

An aspect of the disclosure is to provide an initialization method, which is suitable for a storage device including an interface, a controller module and a memory module. The initialization method includes following steps. A vendor command is provided from a host device via the interface to trigger a first firmware stored in the controller module of the storage device, so as to activate an initialization to the storage device. A second firmware is installed into the memory module of the storage device according to an instruction inputted from the host device via the interface and delivered by the controller module. The storage device is initialized by the triggered first firmware and the second firmware.

Another aspect of the disclosure is to provide a storage device, which includes a functional module, a memory module and a controller module. The functional module is configured for performing a predetermined function. The memory module is configured for storing digital information and a second firmware to be executed for processing the digital information. The controller module is coupled to the functional module and the memory module. The controller module includes a first storage area for storing a first firmware to be executed for driving the functional module and processing an initialization process of the memory module. The first firmware is triggered to active an initialization process by receiving a vendor command from a host device. The controller module is configured to deliver an instruction provided from the host device to the memory module after the first firmware is triggered. The second firmware is generated and installed into the memory module according to the instruction after the initialization process is activated.

Another aspect of the disclosure is to provide an initialization system, which includes a storage device and a host device. The storage device includes an interface, a functional module, a memory module and a controller module. The functional module is configured for performing a predetermined function. The memory module includes a memory controller coupled to a second storage area. The second storage area configured for storing digital information and a second firmware to be executed for processing the digital information. The controller module is coupled to the interface, the functional module and the memory module. The controller module includes a first storage area for storing a first firmware to be executed for driving the functional module and processing an initialization process of the memory module. The host device is configured for providing a vender command and an instruction to the storage device via the interface. The vender command is utilized to trigger the first firmware to activate the initialization process. After the first firmware is triggered by the vendor command, the controller module is configured to deliver the instruction to the memory controller of the memory module, and the second firmware is then generated and installed into the second storage area according to the instruction.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram illustrating an initialization system according to an embodiment of this disclosure;

FIG. 2 is a flow-chart illustrating an initialization method according to an embodiment of the disclosure.

FIG. 3A is a schematic diagrams illustrating the initialization system before a second firmware is established by an initialization process.

FIG. 3B is a schematic diagrams illustrating the initialization system after the second firmware is established by the initialization process.

### DETAILED DESCRIPTION

The following disclosure provides many different embodiments, or examples, for implementing different features of the disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

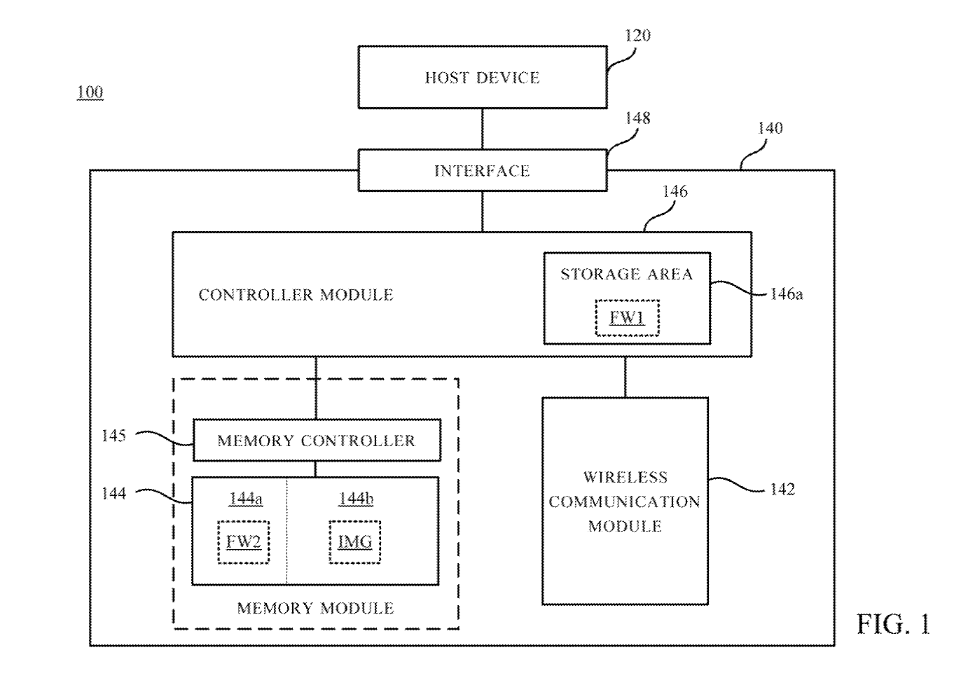

Reference is made to FIG. 1, which is a schematic diagram illustrating an initialization system 100 according to an embodiment of this disclosure. As shown in FIG. 1, the initialization system 100 includes a host device 120 and a storage device 140.

In the embodiment shown in FIG. 1, the storage device 140 includes a wireless communication module 142, a storage area 144, a memory controller 145, a controller module 146 and an interface 148. In practical applications, the storage device 140 can be a memory card with wireless communicative ability. For example, the storage device 140 can be a Secure Digital (SD) memory card capable for forming a Wireless Fidelity (Wi-Fi) wireless connection, or known as a Wi-Fi SD card.

In practices, the storage device 140 includes a casing (not shown in FIG. 1). The wireless communication module 142, the storage area 144, the memory controller 145 and the controller module 146 of the storage device 140 is packaged within the casing. The casing is sized to be accommodated within a socket or slot of an electronic device, for instance a digital camera host (not shown in FIG. 1). For example, the storage device 140 can be inserted into a memory slot of the digital camera host, such that the digital image information IMG (e.g., photos) captured by the digital camera host can be transmitted to the storage device 140 through the interface 148. It should be noticed that the digital image information IMG can be any other formats of digital information according to the type of the electric device host.

In this embodiment, the storage area 144 and the memory controller 145 are configured to form a memory module, which is utilized to store the digital image information IMG captured by the digital camera host. In an embodiment, the memory module can be a flash memory module, but not limited thereto. In other embodiments, the memory module can be a volatile memory module or a non-volatile memory module. The storage area 144 of the memory module is configured for storing the digital image information IMG and also a second firmware FW2. In some embodiments, the storage area 144 can be a flash memory unit of the memory module. In this embodiment, the storage area 144 includes a hidden region 144a and a public region 144b. In general, the flash memory unit includes many memory cells. The memory cells have different specifications, such as reliability, response time, etc. In the preferred embodiment, the memory cells with relative high reliability are assigned to implement the hidden region 144a, and the second firmware FW2 is installed and stored in the hidden region 144a. In general, the hidden region 144a is invisible to normal users and inaccessible to unauthorized application programs. On the other hand, the public region 144b is substantially visible to normal users and is accessible to most of application programs. In this embodiment, the digital image information IMG is stored in the public region 144b as shown in FIG. 1.

The memory controller 145 is configured for receiving an instruction delivered by the controller module to installed the second firmware into the hidden region 144a of the storage area 144, this part will be particularly described later. The memory controller 145 is also configured for controlling a writing process of the digital image information IMG to the storage area 144, and controlling a reading process of the digital image information IMG from the storage area 144. The memory controller 145 is operated according to the second firmware FW2. The second firmware FW2 can be utilized for processing the writing or reading activity of the digital image information IMG in the storage area 144. For example, the second firmware FW2 includes instruction sets for accessing the storage area 144 and detail parameters (e.g., sizes, operational voltages, speeds and response times) of the storage area 144.

The wireless communication module 142 is configured for performing a wireless transmission to an external electronic device, such as a tablet computer, a smart phone or a laptop computer. The wireless communication module 142 can be utilized to share the digital image information IMG stored in the storage device 140 with the external electronic device. It should be noticed that the wireless communication module 142 described in this embodiment can be replaced by another functional module in different embodiments of the present invention.

The controller module 146 is coupled to the wireless communication module 142, the memory module (i.e., the storage area 144 and the memory controller 145) and the interface 148. The controller module 146 is utilized as a bridge to interchange information between the wireless communication module 142, the memory module (i.e., the storage area 144 and the memory controller 145) and the interface 148. The controller module 146 includes a storage area 146a for storing a first firmware FW1 to be executed for driving the wireless communication module 142 and processing an initialization process of the memory module (i.e., the storage area 144 and the memory controller 145). The storage area 146a can be a read-only memory (ROM) configured in the controller module 146.

It is noticed that, the storage device 140 in this embodiment must be initialized before it can function aforesaid operations properly (including the writing/reading process of the flash memory unit). In the embodiment, the second firmware FW2 is not existed in the storage device 140 before the storage device 140 is processed the initialization process. The second firmware FW2 is generated after the initialization process is activated.

The host device 120 of the initialization system 100 shown in FIG. 1 is configured for providing a vender command to the interface 148 of the storage device 140 for activating the initialization process. The host device 120 in the embodiment can be an initialization server with a memory card reader or an equivalent memory interface, and can be used for initializing the storage device 140. Details of the initialization process and an initialization method are disclosed in following paragraphs.

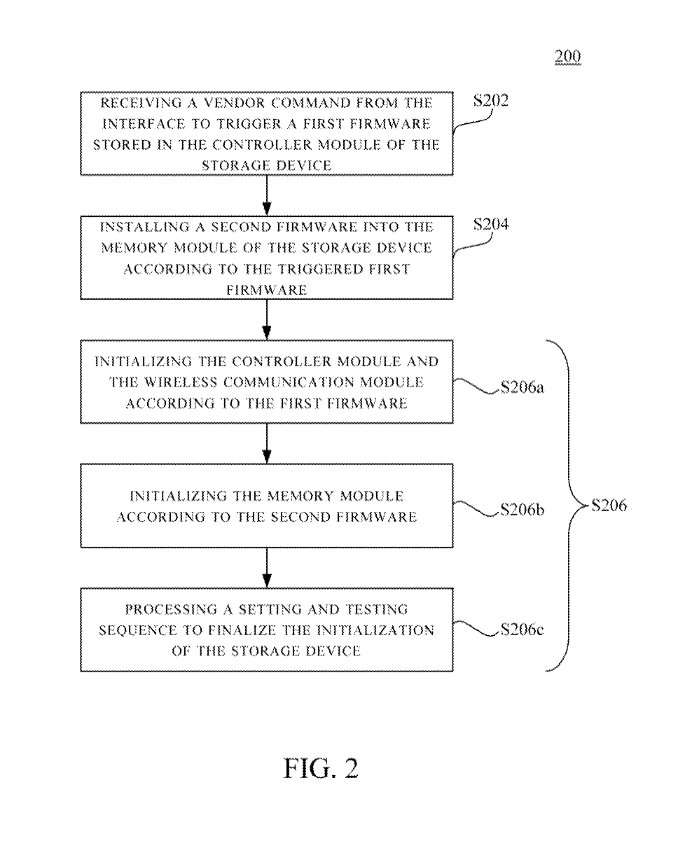

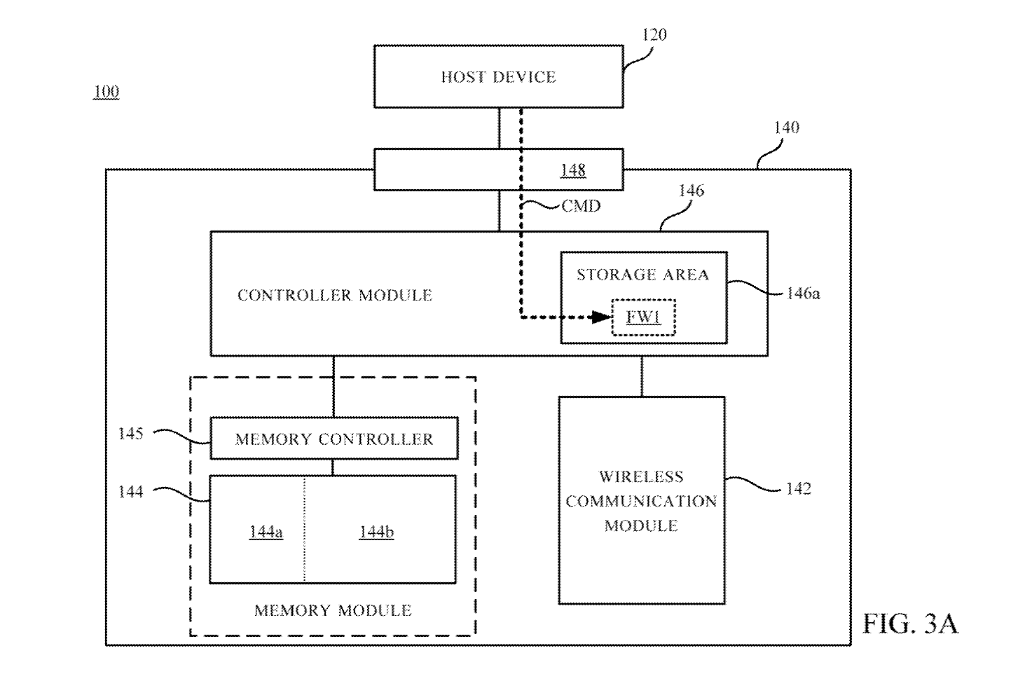

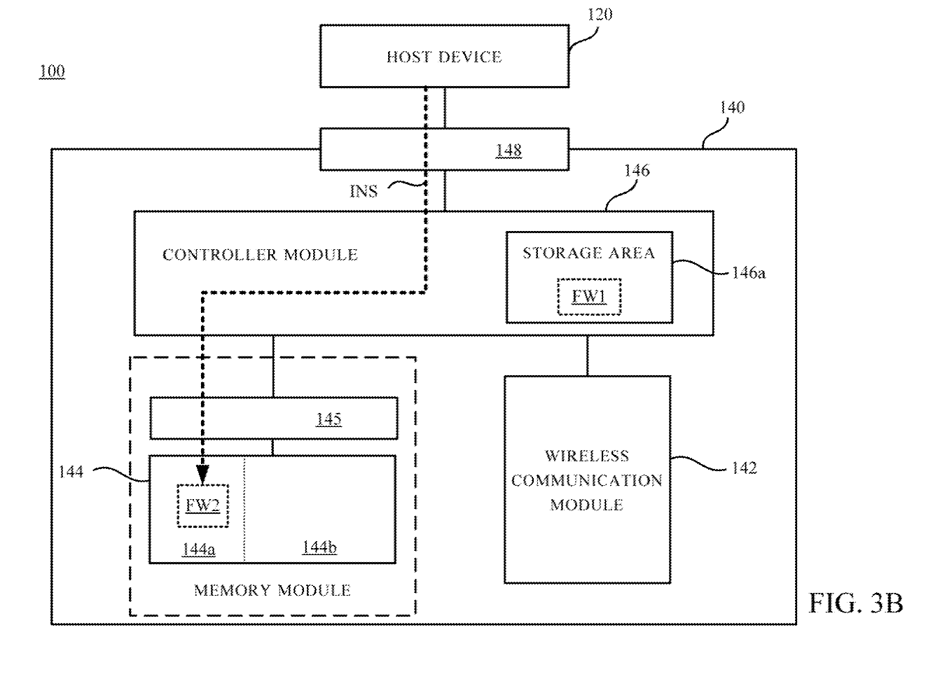

Reference is made to FIG. 2, FIG. 3A and FIG. 3B. FIG. 2 is a flow-chart illustrating an initialization method 200 according to an embodiment of the disclosure. The initialization method 200 can be operated on the initialization system 100. FIG. 3A and FIG. 3B are schematic diagrams illustrating the initialization system 100 before and after the second firmware FW2 is installed by the initialization process.

At the beginning of the initialization process, as shown in FIG. 2 and FIG. 3A, the first firmware FW1 is stored in the storage area 146a of the controller module 146. Step S202 is executed for receiving a vendor command CMD via the interface 148 to trigger the first firmware FW1 stored in the controller module 146 of the storage device 140 to activate the initialization process. In the embodiment, the vendor command CMD is provided by a host device 120 to the storage device 140 via the interface 148. In some embodiments, the vendor command CMD includes configuration data provided by a vendor of the memory module (i.e., the storage area 144 and the memory controller 145).

In some embodiment, the first firmware FW1 is further utilized for driving the wireless communication module 142 to perform a wireless transmission to an external electronic device, such as a tablet computer, a smart phone or a laptop computer for sharing/transmitting information.

After the first firmware FW1 is triggered by the vendor command CMD to activate the initialization process, the controller module 146 is configured to deliver an instruction INS inputted from the host device 120 via the interface 148 to the memory controller 145 of the memory module (as shown in FIG. 3B).

The instruction INS is provided by the host device 120, which can include an initialization tool in this embodiment. Contents of the instruction INS includes instruction data to trigger the initialization process and related information about the storage area 144 and the memory module, such as instruction sets for accessing the storage area 144 and detail parameters (e.g., sizes, operational voltages, speeds and response times) of the storage area 144.

As shown in FIG. 2 and FIG. 3B, step S204 is executed for installing (or establishing) the second firmware FW2 into the memory module (i.e., the storage area 144 and the memory controller 145) of the storage device 140 according to the instruction INS. The second firmware FW2 is generated by the host device 120 according to the instruction INS shown in FIG. 3B.

Afterward, as shown in FIG. 2 and FIG. 3B, step S206 is executed for initializing the storage device 140 according to the first firmware FW1 and the second firmware FW2.

As shown in FIG. 2, step S206 in some embodiments further include three steps S206a˜S206c. Step S206a is executed for initializing (e.g., setting up, testing, verifying, de-bugging and/or demonstrating) the controller module 146 and the wireless communication module 142 after the first firmware FW1 is triggered by the vendor command.

Step S206b is executed for initializing (e.g., formatting, dividing the hidden region 144a and the public region 144b, configuring and/or setting up) the memory module (i.e., the storage area 144 and the memory controller 145) by the processed second firmware FW2.

Step S206c is executed for processing a setting and testing sequence onto the storage area 144 and the memory controller 145 of the memory module and other components (e.g., the interface 148 and other equivalent components) of the storage device 140, so as to finalize the initialization of the storage device 140. In some embodiment, the testing sequence includes testing, verifying, de-bugging and/or demonstrating to the storage device 140. For example, the testing sequence includes but not limited to verifying reliabilities of the hidden region 144a and the public region 144b.

In this case, referring to FIG. 3A and FIG. 3B, the second firmware FW2 is loaded and installed into the memory module (i.e., the storage area 144 and the memory controller 145) after the initialization process is activated by the vendor command CMD. When the manufacturer of the storage device 140 tends to replace/update/change the storage area 144 or the memory module into another model (e.g., another product from the same vender or another product from a different vendor), the manufacturer is not required to re-design the whole structure of the storage device 140. The manufacturer can easily implement another version of the second firmware FW2 by providing an updated vendor command CMD of a corresponding version, such that the second firmware FW2 of the new version can be installed through the initialization process.

In this document, the term “coupled” may also be termed as “electrically coupled”, and the term “connected” may be termed as “electrically connected”. “Coupled” and “connected” may also be used to indicate that two or more elements cooperate or interact with each other. It will be understood that, although the terms “first,” “second.” etc., may be used herein to describe various elements, these elements should not be limited by these terms. These terms are used to distinguish one element from another. For example, a first element could be termed a second element, and, similarly, a second element could be termed a first element, without departing from the scope of the embodiments. As used herein, the term “and/or” includes any and all combinations of one or more of the associated listed items.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An initialization method, suitable for a storage device comprising an interface, a controller module and a memory module, comprising:
receiving a vendor command provided from a host device via the interface to trigger a first firmware stored in the controller module of the storage device to activate an initialization to the storage device;
installing a second firmware into the memory module of the storage device according to an instruction inputted from the host device via the interface and delivered by the controller module; and
initializing the storage device by the triggered first firmware and the second firmware.

2. The initialization method of claim 1, wherein the storage device further comprising a functional module, and the step of initializing the storage device comprises:
initializing the controller module and the functional module by the triggered first firmware; and
initializing the memory module by the second firmware.

3. The initialization method of claim 2, wherein the step of initializing the storage device further comprises:
processing a setting and testing sequence to finalize the initialization of the storage device.

4. The initialization method of claim 2, wherein the first firmware is further utilized for driving the functional module to perform a wireless transmission.

5. The initialization method of claim 1, wherein the storage device is connected to the host device through the interface to be able to receive the vendor command provided by the host device for initializing the storage device.

6. The initialization method of claim 5, wherein the second firmware is generated according to the instruction provided by the host device.

7. The initialization method of claim 1, wherein the memory module comprises a memory controller and a storage area having a hidden region and a public region, and the step of installing the second firmware into the memory module of the storage device according to the instruction inputted from the host device via the interface further comprising:
installing the second firmware into the hidden region of the storage area.

8. A storage device, comprising:
a functional module configured for performing a predetermined function;
a memory module configured for storing digital information and a second firmware to be executed for processing the digital information; and
a controller module coupled to the functional module and the memory module, wherein the controller module comprises a first storage area for storing a first firmware to be executed for driving the functional module and processing an initialization process of the memory module;
wherein the first firmware is triggered to active an initialization process by receiving a vendor command from a host device, and the controller module is configured to deliver an instruction provided from the host device to the memory module after the first firmware is triggered;
wherein the second firmware is generated and installed into the memory module according to the instruction after the initialization process is activated.

9. The storage device of claim 8, wherein the memory module comprises:
a second storage area configured for storing the digital information and the second firmware; and
a memory controller coupled to the controller module and the second storage area, configured for receiving the instruction delivered by the controller module to installed the second firmware into the second storage area, and for controlling a writing process and a reading process related to the second storage area, and the memory controller being operated by the second firmware.

10. The storage device of claim 9, wherein the second storage area comprises:
a hidden region, configured for storing the second firmware after the first firmware is triggered to activate the initialization process; and
a public region, configured for storing the digital information.

11. The storage device of claim 10, wherein the hidden region is implemented with a first reliability higher than a second reliability of the public region.

12. The storage device of claim 8, further comprising:
a casing sized to be accommodated within a slot of the host device; and
an interface configured for connecting to the digital camera host and receiving the digital information from the host device.

13. The storage device of claim 8, wherein the initialization process is triggered when a vendor command is received by the controller module.

14. The storage device of claim 13, wherein content of the second firmware is adjustable according to the instruction.

15. An initialization system, comprising:
a storage device, comprising:
an interface;
a functional module configured for performing a predetermined function;
a memory module comprising a memory controller coupled to a second storage area, and the second storage area configured for storing digital information and a second firmware to be executed for processing the digital information; and
a controller module coupled to the interface, the functional module and the memory module, wherein the controller module comprises a first storage area for storing a first firmware to be executed for driving the functional module and processing an initialization process of the memory module; and
a host device configured for providing a vender command and an instruction to the storage device via the interface;
wherein the vender command is utilized to trigger the first firmware to activate the initialization process, after the first firmware is triggered by the vendor command, the controller module is configured to deliver the instruction to the memory controller of the memory module, and the second firmware is then generated and installed into the second storage area according to the instruction.

16. The storage device of claim 15, wherein the second storage area comprises:
a hidden region, configured for storing the second firmware; and
a public region, configured for storing the digital information.

17. The storage device of claim 16, wherein the hidden region is implemented with a first reliability higher than a second reliability of the public region.

18. The storage device of claim 15, wherein content of the second firmware is adjustable according to the instruction.
